(19) United States
(12) Patent Application Publication
(10) Pub. No.: US 2024/0343226 A1
(43) Pub. Date: Oct. 17, 2024

(54) WIPER WITH ELEMENT FOR SPRAYING CLEANING FLUID

(71) Applicant: VALEO SYSTÈMES D'ESSUYAGE, Le Mesnil Saint Denis (FR)

(72) Inventors: Vincent Izabel, Le Mesnil Saint Denis (FR); Frederic Giraud, Le Mesnil Saint Denis (FR); Alexandre Filloux, Le Mesnil Saint Denis (FR); Gerald Caillot, Le Mesnil Saint Denis (FR); Jean Michel Jarasson, Le Mesnil Saint Denis (FR)

(73) Assignee: VALEO SYSTÈMES D'ESSUYAGE, Le Mesnil Saint Denis (FR)

(21) Appl. No.: 18/293,497

(22) PCT Filed: Jul. 29, 2022
(86) PCT No.: PCT/EP2022/071446

§ 371 Date: Jan. 30, 2024

(30) Foreign Application Priority Data
Jul. 30, 2021 (FR) FR2108348
Jul. 30, 2021 (FR) FR2108355

(51) Int. Cl. B60S 1/52; B60S 1/48

(52) U.S. Cl. CPC B60S 1/522; B60S 1/482

(57) ABSTRACT

A wiper for a glazed surface of a vehicle is disclosed. The wiper includes at least one structural element, a wiper rubber carried by the structural element, at least one end piece arranged at a longitudinal end of the structural element, at least one conduit extending in a main direction of elongation of the wiper, and at least one spray element fluidically connected to the conduit and formed on the structural element. The wiper rubber is configured to bear against the glazed surface and to sweep a wiping zone of the glazed surface. The spray element is configured to spray cleaning fluid in a spray direction onto an additional zone distinct from the wiping zone.

The present invention relates to the field of optical systems for vehicles, and more specifically to a cleaning device for such optical systems.

In an increasingly innovative automobile sector, there is widespread development of optical systems such as radars, reversing cameras, or more recently LIDAR systems, notably for autonomous vehicles. The issue of cleaning such optical systems arises immediately, given that they need a constant clear field of vision to ensure optimum operation.

Some of these optical systems can be arranged so as to be built into a glazed surface of a vehicle or arranged near to said glazed surface. The vehicle further comprises a wiper system comprising a wiper that is notably intended to wipe the aforementioned glazed surface.

Car manufacturers are constantly striving to improve their vehicles. Such improvements notably include installing a cleaning device for an optical system positioned on or near a glazed surface swept by a wiper system. Such a cleaning device must preferably be arranged such as to minimize as much as possible additions required to install this cleaning device.

The present invention provides a solution for this potential improvement by proposing a wiper for a glazed surface of a vehicle comprising:
at least one structural element,
a wiper rubber carried by the structural element, the wiper rubber being configured to bear against the glazed surface and to sweep a wiping zone of the glazed surface, and
at least one end piece arranged at a longitudinal end of the structural element,
at least one conduit extending in a main direction of elongation of the wiper,
at least one spray element fluidically connected to the conduit and formed on the structural element,
   the spray element being configured to spray cleaning fluid in a spray direction onto an additional zone distinct from the wiping zone.

This wiper thus enables cleaning fluid to be sprayed onto an optical system arranged near to or in the glazed surface, said optical system not being arranged on a path of the wiper rubber. Furthermore, incorporating the spray element into the wiper obviates the need to install a separate cleaning device, which could create mechanical bulk.

It is understood that there is no overlap between the wiping zone and the additional zone.

Indeed, the additional zone may be an optical surface of an optical system. The optical surface may be distinct from the glazed surface.

The optical surface may be a portion of the glazed surface distinct from the wiping zone, i.e. not wiped by the wiper, i.e. outside the wiping zone. It is understood that the main direction of elongation of the blade is a longitudinal direction of the wiper.

The structural element of the wiper forms the body thereof, and notably enables the wiper rubber to be held mechanically despite the mechanical stress with the glazed surface when the wiper is in motion, in order to wipe the glazed surface. The end piece helps to hold at least the structural element and the wiper rubber together by closing the longitudinal end of the wiper.

For example, the conduit is formed at least in part in the structural element to limit the mechanical bulk, to not interfere with the wiping of the glazed surface, and to not affect the aerodynamics of the wiper. The conduit provides a fluidic connection between the spray element and a cleaning fluid tank.

The conduit conveys the cleaning fluid from a tank of cleaning liquid to the spray element.

In some embodiments, the spray direction is oriented at an opening angle of between 0° and 30° in relation to the main direction of elongation of the wiper in a first plane configured to be substantially parallel to the glazed surface.

The blade is defined by the main direction of elongation, which is the longitudinal direction of the wiper. The wiper is also defined by a transverse direction of extension perpendicular to the main direction of elongation. The transverse direction of extension is configured to be substantially parallel to the glazed surface when the blade is arranged against the glazed surface. The wiper is also defined by a vertical direction of extension perpendicular to the main direction of elongation and the transverse direction of extension. The vertical direction of extension is configured to be substantially perpendicular to the glazed surface when the blade is arranged against the glazed surface. The main direction of elongation and the transverse direction of extension are inscribed in a first plane. The transverse direction of extension and the vertical direction of extension are inscribed in a second plane.

For example, the opening angle is between 0° and 20°.

For example, the opening angle is between 0° and 10°.

For example, the opening angle is between 3° and 30°.

For example, the opening angle is between 3° and 20°.

For example, the opening angle is between 3° and 10°.

For example, the opening angle is between 5° and 30°.

For example, the opening angle is between 5° and 15°.

In some embodiments, the spray element comprises at least one spray channel that extends in the spray direction of a jet of cleaning fluid.

The spray channel enables the cleaning fluid spray to be oriented so that the latter is sprayed onto the optical system to be cleaned, from the wiper.

The opening angle of between 3° and 30° defines a section centered about the main direction of elongation of the wiper. The spray direction is such that it passes through this section formed by the opening angle. The opening angle thus helps to define a spray direction of the jet of cleaning fluid so that the latter can reach and clean an optical surface of the optical system, or a portion of the glazed surface, the optical system being positioned in said portion.

According to one feature of the invention, the spray direction is oriented at an attitude angle of between −30° and 20° in relation to a transverse direction of extension perpendicular to the main direction of elongation, in a second plane configured to be substantially perpendicular to the glazed surface. The attitude angle defines a portion of the section defined by the opening angle to specify the spray direction of the jet of cleaning fluid sprayed via the spray element. The transverse direction of extension used as a basis to define the attitude angle is parallel or substantially parallel to the glazed surface wiped by the wiper.

For example, the attitude angle is between −30° and 10°.

For example, the attitude angle is between −20° and 10°.

For example, the attitude angle is between −5° and 20°.

For example, the attitude angle is between −10° and 5°.

The combination of the opening angle and the attitude angle provides a specific orientation range ensuring an optimal spray direction for the optical system to be cleaned.

According to one feature of the invention, the spray element is formed in the structural element. In other words, the spray channel is formed through a wall of the structural element delimiting the conduit. In other words, the spray channel may be an opening. For example, the opening is formed through the material of the structural element of the wiper and opening into the conduit.

According to another feature of the invention, the spray element is attached to the structural element so as to be in fluidic communication with the conduit. The spray element may be joined to the conduit and thus project from the wiper in the form of a separate component of the structural element.

For example, the spray element is a nozzle.

According to one feature of the invention, the wiper comprising at least one spray device configured to spray cleaning liquid onto the wiping zone.

For example, the spray device comprises at least one orifice.

In some embodiments, the spray device is formed on the structural element.

For example, the spray device is formed in a connection portion of the blade to a drive arm.

The conduit is hereinafter referred to as the first conduit. For example, the wiper comprises a second conduit in fluidic communication with the spray device. For example, the second conduit is configured to convey cleaning fluid from a cleaning fluid tank to the spray device.

In some embodiments, the spray device comprises a plurality of spray orifices, said spray orifices being arranged along the main direction of elongation of the wiper.

It is understood that the plurality of spray orifices is in fluidic communication with the second conduit.

For example, said spray orifices are distributed along the main direction of elongation of the wiper. For example, said spray orifices are distributed along the main direction of elongation of the wiper uniformly.

Such a configuration enables the wiper to provide two separate fluid sprays, specifically a first fluid spray toward the optical system via the spray element as described above, and a second fluid spray via the spray device to clean the wiping zone of the glazed surface. The cleaning fluid sprayed by the spray device is thus sprayed onto the glazed surface in the wiping zone and the moving wiper then wipes the glazed surface.

The first and second conduits can be connected to a single cleaning fluid tank or can be connected to a dedicated cleaning fluid tank.

In some embodiments, the spray element is configured to spray the cleaning fluid from a first side of the wiper and the spray device is configured to spray the fluid from a second side of the wiper, opposite the first side in relation to the main direction of elongation of the wiper.

It is understood that the wiper comprises a midplane perpendicular to the plane passing through at least the spine forming the structural element of the wiper, the spray element being oriented toward a first side of the midplane and the spray orifices being oriented toward a second side of the midplane, the second side being opposite the first side in relation to the midplane. In other words, the midplane is perpendicular or substantially perpendicular to a plane of elongation of the glazed surface wiped by the wiper.

The fluid spray jets are thus oriented so as not to interfere with one another.

As described above, the additional zone may be either an optical surface of an optical system, said optical surface being separate from the glazed surface, or a portion of the glazed surface not wiped by the wiper, i.e. outside the wiping zone.

The invention also relates to a wiper system for a vehicle, comprising a wiper as described above, an arm for moving the wiper and a cleaning device that is connected fluidically to the spray element and configured to control the circulation of the cleaning fluid. The arm may for example be moved when the glazed surface and/or the optical surface of the optical system have to be cleaned. The arm then drives the wiper in a reciprocating motion, the wiper rubber being in direct contact with and wiping the glazed surface.

The cleaning device comprises at least the conduit and the spray element described above, as well as the cleaning fluid tank also mentioned above. Such a cleaning device is activated when the cleaning fluid needs to be sprayed onto the additional zone, i.e. the zone containing the optical surface of the optical system needs to be cleaned.

According to one feature of the invention, the cleaning device comprises at least one solenoid valve configured to permit the cleaning fluid to circulate to the spray element and a control module for said solenoid valve. The control module enables the solenoid valve to be electronically controlled, to open or close the solenoid valve. The solenoid valve may for example be controlled following a manual command made by a user of the vehicle, or automatically, for example at regular intervals of time, or if dirt is detected in the additional zone.

When the solenoid valve is open, the cleaning fluid can then circulate through the conduit to be sprayed by the spray element. Conversely, if the solenoid valve is closed, the cleaning fluid does not circulate and is hence not sprayed.

According to one feature of the invention, the control module can open or close the solenoid valve as a function of a given angular position of the wiper during the movement thereof. In other words, the circulation and spraying of the cleaning fluid are only permitted if the spray direction of the sprayed jet reaches the additional zone in order to clean the optical system. It is therefore the angular position of the moving wiper that determines the moment at which the spray element is facing the additional zone, and that it is therefore time to spray cleaning fluid. The control module therefore receives signals making it possible to define the angular position of the wiper, and controls the solenoid valve as a function of said received signals.

According to one feature of the invention, the wiper system comprises an electronically controlled electric motor able to move the arm with the wiper arranged at the end thereof, the angular position of the wiper being determined by the electronically controlled electric motor. The electronically controlled electric motor may be activated when the additional zone and/or the wiping zone have to be cleaned. The arm and by extension the wiper are therefore moved by the electronically controlled electric motor that, in parallel with this movement, is able to determine the angular position of the wiper and to transmit this angular position to the control module to enable the latter to control the solenoid valve to spray the cleaning fluid so that the latter reaches the additional zone.

According to one feature of the invention, the control module is configured to open or close the solenoid valve during an upward movement phase of the wiper. Spraying the cleaning fluid during the upward movement phase of the wiper is advantageous since the upward movement phase helps to limit the circulation of the cleaning fluid along the glazed surface after spraying said fluid, compared to a cleaning fluid sprayed during the downward movement phase of the wiper.

According to one feature of the invention, the wiper system comprises a cleaning fluid circuit provided with a cleaning fluid tank, a pump configured to circulate the cleaning fluid, and a distribution member configured to distribute the fluid to the first conduit and/or to the second conduit, the distribution member comprising an electro-valve configured to enable the cleaning fluid to circulate to the spray orifices. Such a configuration is used when the wiper according to the invention also has the plurality of spray orifices, which requires the cleaning fluid circulation to be separated to enable the cleaning fluid to be sprayed via the spray element or via the spray orifices.

The cleaning fluid tank is as described above and enables the cleaning fluid to be stored. Such a tank may for example be filled manually by the user of the vehicle. The pump circulates the cleaning fluid to the distribution member. The latter enables the cleaning fluid circuit to be split so that the cleaning fluid can reach the first conduit or the second conduit.

The electromagnetic valve may have the same features and the same functions as the solenoid valve described above, i.e. able to permit or prevent the circulation to the second conduit, and therefore to the spray orifices. When the pump is running and the electromagnetic valve is closed, the cleaning fluid can then circulate to the first conduit and to the spray element. The cleaning fluid circuit is then arranged according to a first embodiment.

According to one feature of the invention, the solenoid valve is arranged on the distribution member. This is a second embodiment of the cleaning fluid circuit with the solenoid valve and the electromagnetic valve controlling access to the first conduit and the second conduit respectively.

According to one feature of the invention, the control module is configured to control the pump, the solenoid valve and the electromagnetic valve as a function of a given angular position of the wiper during the movement thereof and a need to clean the wiping zone traveled by the wiper and/or the additional zone. The presence of the electromagnetic valve and the solenoid valve makes it possible for the cleaning fluid spray to be controlled in a coordinated manner with the position of the wiper, and makes it possible to permit spraying only if cleaning is required. This helps to save cleaning fluid by preventing said fluid from being sprayed needlessly, or from being wasted by being sprayed outside the wiping zone and the additional zone.

As described above, the control module can activate or deactivate the pump, and open or close the electromagnetic valve and the solenoid valve in relation to the angular position of the wiper, which may for example be determined by the electronically controlled electric motor mentioned above.

According to one feature of the invention, the cleaning device comprises a cleaning fluid tank, a first pump and a second pump configured to aspirate the cleaning fluid stored in the cleaning fluid tank, as well as a first pipe fluidically connecting the first pump to the first conduit and a second pipe fluidically connecting the second pump to the second conduit. This is a third embodiment of the cleaning fluid circuit. This third embodiment does not include a distribution member, electromagnetic valve or solenoid valve, since each conduit receives cleaning fluid from a source that is separate from the other sources. This embodiment thus requires two pumps to circulate the cleaning fluid to the spray element or to the spray orifices.

According to one feature of the invention, the wiper system comprises a control module able to activate or deactivate the first pump and/or the second pump as a function of a given angular position of the wiper during the movement thereof and a need to clean the wiping zone traveled by the wiper and/or the additional zone. The control module operates in a manner similar to the manner described above, with the exception that the control module in this case only controls the operation of the first pump and the second pump as a function of what needs to be cleaned and the angular position of the wiper.

Further features and advantages of the invention will become more clearly apparent both from the following description and from several exemplary embodiments, which are given by way of nonlimiting indication with reference to the attached schematic drawings, in which:

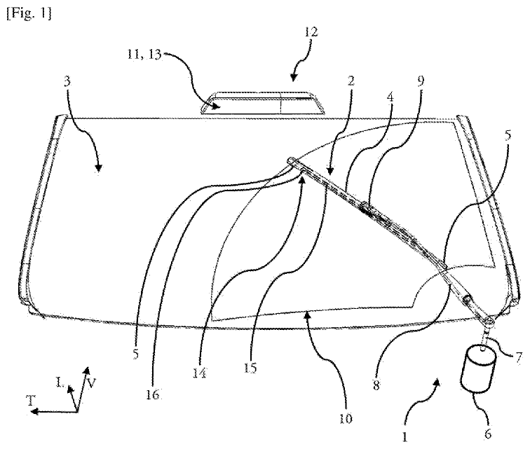

FIG. 1 is an overview of a wiper system comprising a wiper according to the invention,

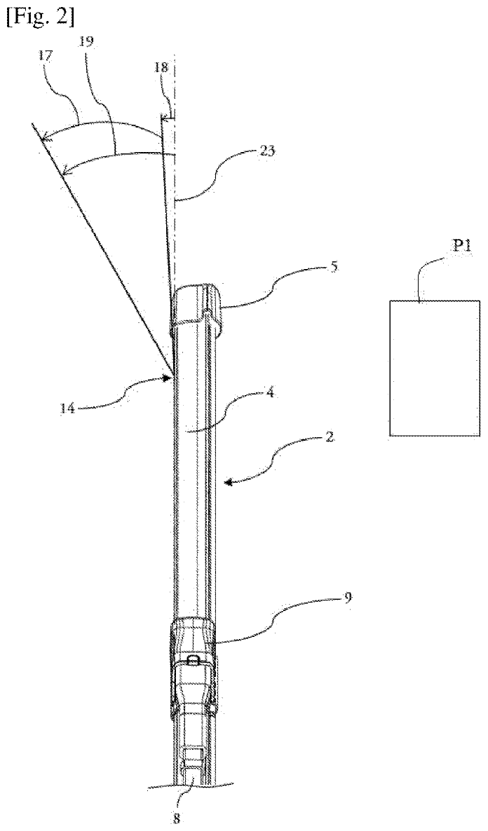

FIG. 2 shows the wiper and illustrates determination of an opening angle of a spray direction of a cleaning fluid via a spray element of the wiper,

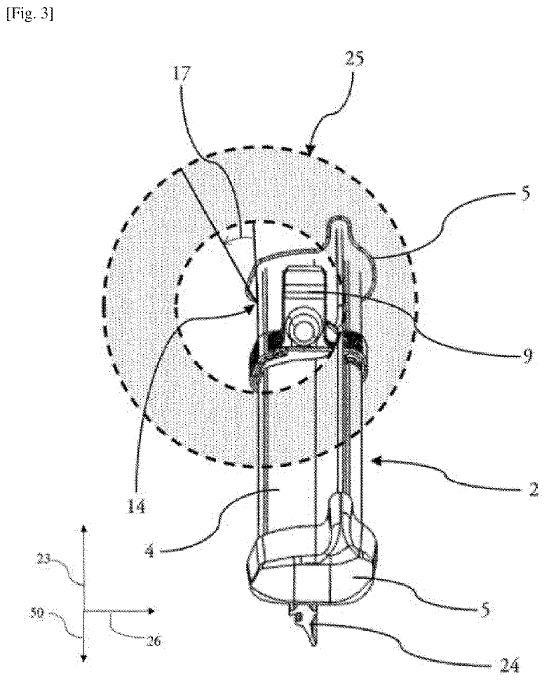

FIG. 3 shows the wiper and illustrates a sector resulting from the determination of the opening angle of the spray direction of the cleaning fluid,

FIG. 4 shows the wiper and illustrates determination of an attitude angle of the spray direction of the cleaning fluid,

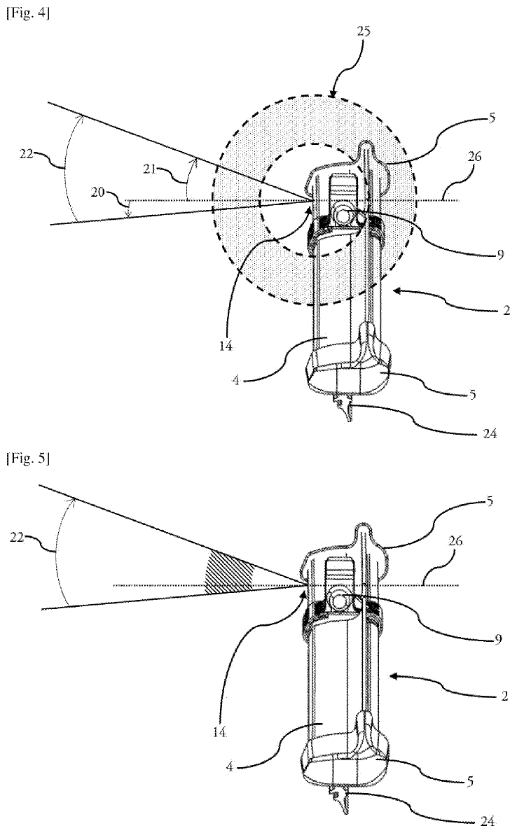

FIG. 5 shows the wiper and illustrates an end portion of the sector resulting from the determination of a combination of the opening angle and the attitude angle,

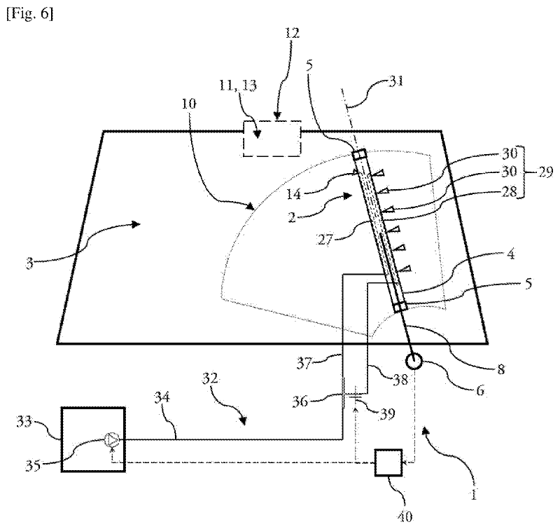

FIG. 6 shows a first embodiment of a cleaning device supplying the wiper with cleaning fluid,

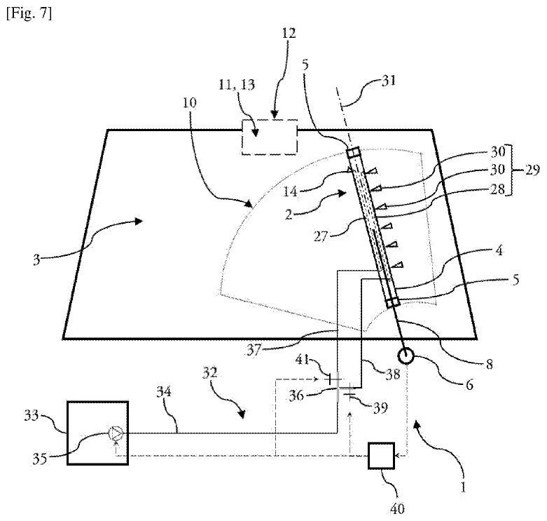

FIG. 7 shows a second embodiment of the cleaning device supplying the wiper with cleaning fluid,

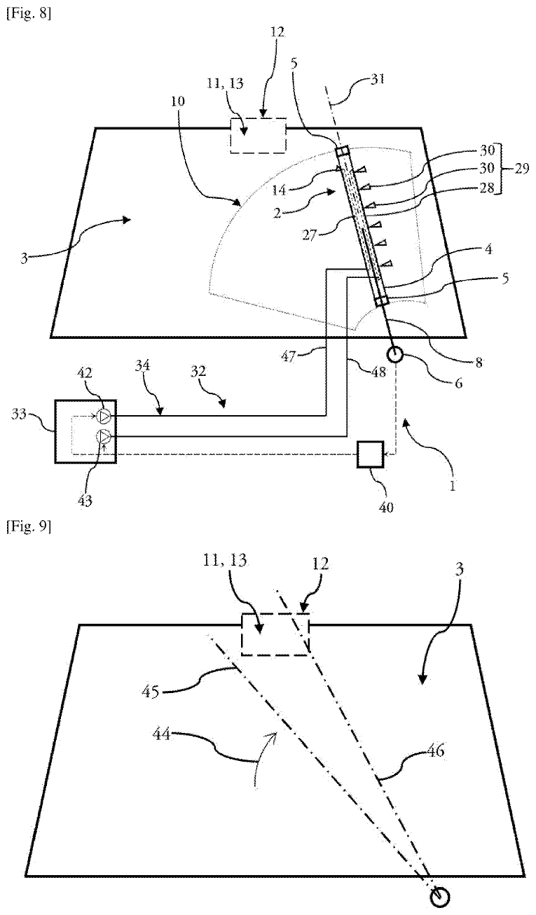

FIG. 8 shows a third embodiment of the cleaning device supplying the wiper with cleaning fluid,

FIG. 9 is a diagram showing a plurality of angular positions of the wiper.

To describe the features of the wiper according to the invention in detail, the trihedron LVT is used to represent the orientation of the various elements in the detailed description. The longitudinal direction L and the transverse direction T correspond to two axes defining a plane parallel to a wiping surface wiped by the wiper, and the vertical direction V corresponds to an axis perpendicular to the longitudinal and transverse directions L, T.

FIG. 1 shows a wiper 2 according to the invention. The wiper 2 is notably configured to wipe a glazed surface 3, for example a windshield of a vehicle, said windshield extending in a longitudinal direction L and a transverse direction T. The wiper 2 comprises a wiper rubber, not shown in FIG. 1, that is intended to wipe the glazed surface 3 by being pressed against said surface. The wiper 2 also comprises a structural element 4 that is notably able to carry the wiper rubber. The structural element 4 is held by two end pieces 5 arranged at each end of the wiper 2.

The wiper 2 is part of a wiper system 1 also comprising an electronically controlled electric motor 6, a shaft 7 and an arm 8. The electronically controlled electric motor 6 is able to drive the shaft 7 in rotation, for example following a manual action by a user of the vehicle, or automatically, for example following detection of raindrops on the glazed surface 3. The shaft 7 is thus driven in rotation about an axis parallel to a vertical direction V.

The arm 8 is in turn fastened to the shaft 7 and is therefore driven by the latter in a reciprocating motion. Since the wiper 2 is fastened to the arm 8, for example by a connector 9, linking the arm 8 and the structural element 4, the wiper 2 is then also driven in a reciprocating motion, and thus wipes the glazed surface 3 with the wiper rubber pressed against the glazed surface 3. A wiping zone 10 is shown in FIG. 1 and delimits a portion of the glazed surface 3 that is wiped by the wiper 2. To ensure that all or nearly all of the glazed surface 3 is wiped, another wiper system 1 with a wiper 2 intended to wipe a portion of the glazed surface 3 other than the wiping zone 10 may be installed.

The vehicle also comprises an optical system 12 that in FIG. 1 overhangs the glazed surface 3. The optical system 12 may be one of various different kinds, for example a radar, a reversing camera or a LIDAR system. The optical system 12 notably comprises an optical surface 13 that must be clean at all times to ensure that the optical system 12 can operate correctly.

The wiper 2 according to the invention fulfills this need to clean the optical system 12 by comprising a spray element 14 that can spray a cleaning fluid, and a conduit 15 formed inside the structural element 4 and enabling said cleaning fluid to circulate to the spray element 14. In FIG. 1, the spray element 14 comprises a spray channel 16 formed directly through a wall delimiting the conduit 15, but the spray element 14 could also be attached to the conduit 15. The spray channel 16 sprays a jet of cleaning fluid in a spray direction to reach the optical surface 13 of the optical system 12, which in this case is an additional zone 11 distinct from the wiping zone 10 mentioned above. The means of determining an orientation of the spray direction is detailed below. The conditions and means for activating and deactivating the spray of cleaning fluid spray via the spray element 14 depend notably on an angular position of the wiper 2, and are also described in detail below.

FIG. 2 is a partial view of the wiper 2 and shows an opening angle 17 at least partially defining the orientation of the spray direction of the jet of cleaning fluid sprayed by the spray element 14.

The wiper 2 is defined by the main direction of elongation 23, which is the longitudinal direction of the wiper 2. The wiper 2 is also defined by a transverse direction of extension 26 perpendicular to the main direction of elongation 23. The transverse direction of extension 26 is configured to be substantially parallel to the glazed surface 3 when the wiper 2 is arranged against the glazed surface 3. The wiper 2 is also defined by a vertical direction of extension 50 perpendicular to the main direction of elongation 23 and the transverse direction of extension 26. The vertical direction of extension 50 is configured to be substantially perpendicular to the glazed surface 3 when the wiper 2 is arranged against the glazed surface 3. The main direction of elongation 23 and the transverse direction of extension 26 are inscribed in a first plane. The transverse direction of extension 26 and the vertical direction of extension 50 are inscribed in a second plane.

The opening angle 17 is between a first angle 18 and a second angle 19, as shown in FIG. 2. The first angle 18 and the second angle 19 are established in relation to a main direction of elongation 23 of the wiper 2 and in the first plane.

The main direction of elongation 23 of the wiper 2 may be parallel to the longitudinal direction, depending on the angular position of the wiper 2. The main direction of elongation 23 is shown in FIG. 2 by an axis passing through the spray element 14 of the wiper 2.

The first angle 18 has a value of 3° in relation to the main direction of elongation 23 of the wiper 2, while the second angle 19 has a value of 30° in relation to the main direction of elongation 23 of the wiper 2. The opening angle 17 is thus defined by the difference between the second angle 19 and the first angle 18, or more generally by the difference between the largest angle and the smallest angle. The spray direction of the jet of cleaning fluid is thus partially defined by the opening angle 17.

Once the opening angle 17 has been established, this angle defines a section 25, as shown in FIG. 3. For the sake of simplicity, the section 25 is shown as a circular section defined by dotted lines, but the actual dimensions of the section 25 vary as a function of a distance from the spray element 14 and the value of the opening angle 17.

It should be noted that FIG. 3 shows the wiper rubber 24 of the wiper 2 mentioned above, which is used to wipe the glazed surface.

To refine the window of orientation of the spray element 14 of the wiper 2 according to the invention, it is also possible to determine an attitude angle 22 using a third angle 20 and a fourth angle 21, as shown in FIG. 4. The third angle 20 and the fourth angle 21, unlike the first angle and the second angle, are determined in relation to the transverse direction of extension 26 in the second plane. The second plane is also parallel to a plane passing through at least one spine forming the structural element 4 of the wiper 2.

The third angle 20 has a value of −5°, while the fourth angle 21 has a value of 20°. The attitude angle 22 corresponds to the sum of the absolute values of the third angle 20 and the fourth angle 21.

The attitude angle 22 thus delimits a portion of the section 25 defined by the opening angle. An example of delimitation of the window of the spray direction of the jet of cleaning fluid determined by a combination of the opening angle and the attitude angle 22 is thus illustrated in FIG. 5, shown by a hatched area.

Once the orientation of the spray direction has been determined, the spray element is then as defined by the invention. FIG. 6 shows a first embodiment of the wiper system 1 according to the invention in detail. It is possible to observe the wiper 2 driven by the arm 8, which is in turn driven by the electronically controlled electric motor 6.

FIG. 6 shows several novel features or alternative features to the features shown in FIG. 1. Thus, the optical system 12 can for example be at least partially built into the glazed surface 3. The additional zone 11 defined above is then at least partially coincident with the glazed surface 3, but is nonetheless still distinct from the wiping zone 10.

The conduit shown in FIG. 1 is a first conduit 27, the wiper system 1 comprising a spray device 29 provided with a second conduit 28 and a plurality of spray orifices 30, in this case.

The spray device 29 sprays cleaning fluid against the glazed surface 3 via the spray orifices 30, and more specifically against the wiping zone 10 of the glazed surface 3. The wiper 2 as shown in FIG. 6 is thus structured to be able to participate in spraying the cleaning fluid against the wiping zone 10 and against the additional zone 11. The second conduit 28 enables the cleaning fluid to circulate to each of the spray orifices 30. As with the first conduit 27, the second conduit 28 is formed in the structural element 4 of the wiper 2.

Once the cleaning fluid has been sprayed onto the wiping zone 10, the wiper 2, by means of the wiper rubber, sweeps the cleaning fluid against the wiping zone 10 in order to clean this zone.

The spray element 14 comprising the spray channel is attached to the first conduit 27, unlike as described above where the spray channel is formed through the wall delimiting the conduit.

The spray element 14 and the spray orifices 30 are arranged such as to be separated by a midplane 31 of the wiper 2 that is perpendicular or substantially perpendicular to the glazed surface 3. Thus, the spray element 14 is oriented towards a first side of this midplane 31, while the spray orifices 30 are arranged towards a second side opposite the first side of this midplane 31.

The wiper system 1 also comprises a cleaning device 32 that is intended to manage the circulation of the cleaning fluid to each of the conduits 27, 28. The cleaning device 32 comprises the cleaning fluid tank 33 mentioned above, as well as a cleaning fluid circuit 34 that provides the fluidic connection between the cleaning fluid tank 33 and the two conduits 27, 28 arranged in the structural element 4 of the wiper 2.

The cleaning device 32 comprises a pump 35 arranged inside the cleaning fluid tank 33. When spraying is required, either to clean the wiping zone 10 or the additional zone 11, the pump 35 is activated to pump the cleaning fluid and to circulate the cleaning fluid through the cleaning fluid circuit 34. The latter comprises a distribution member 36 that divides the cleaning fluid circuit 34 into two branches, each of the branches being able to convey the cleaning fluid to one of the conduits 27, 28 of the wiper 2. The cleaning fluid circuit 34 thus comprises a first branch 37 that can circulate the cleaning fluid to the first conduit 27, and a second branch 38 that can circulate the cleaning fluid to the second conduit 28. The first branch 37 and the second branch 38 extend between the distribution member 36 and the respective conduit 27, 28 thereof, to which the branches 37, 38 are fluidically connected.

The distribution member 36 further comprises an electromagnetic valve 39 that is intended to control access of the cleaning fluid to the second branch 38. The electromagnetic valve 39 is thus able to permit or prevent access to the second branch 38, and therefore to the second conduit 28 and to the spray orifices 30. The electromagnetic valve 39 is useful in that it can switch to the open position or the closed position as a function of the need to spray cleaning fluid on the wiping zone 10 to clean this zone. Thus, when it is necessary to spray cleaning fluid only on the additional zone 11, the electromagnetic valve 39 is closed, whereas when it is necessary to spray cleaning fluid on the wiping zone 10, the electromagnetic valve 39 is open.

The electromagnetic valve 39 can switch to the open position or the closed position to spray or not spray cleaning fluid via the spray orifices 30. So as not to waste cleaning fluid, the spraying of cleaning fluid depends on the angular position of the wiper 2. The cleaning device 32 hence comprises a control module 40 that manages operation of the pump 35 and the electromagnetic valve 39, and activates or deactivates them as required. By way of example, cleaning fluid is only sprayed via the spray element 14 when the latter is facing the additional zone 11, so as to only spray the cleaning fluid against the optical surface 13 of the optical system 12.

It is understood from the foregoing that the spraying of cleaning fluid is dependent on the angular position of the wiper 2. Such an angular position is monitored by the electronically controlled electric motor 6 used to move the wiper 2. The control module 40 thus receives signals from the electronically controlled electric motor 6, said signals relating to the angular position of the wiper 2. The control module 40 controls the pump 35 and the electromagnetic valve 39 as a function of the angular position and the need to clean the wiping zone 10 and/or the additional zone 11.

FIG. 7 shows a second embodiment of the wiper system 1. This second embodiment is similar to the first embodiment, with the difference that, in addition to comprising the electromagnetic valve 39, the wiper system also comprises a solenoid valve 41 that is arranged on the distribution member 36 and that controls the circulation of the cleaning fluid to the first conduit 27, and therefore to the spray element 14. The control module 40 is therefore also able to control the opening and closing of the solenoid valve 41, in addition to controlling the electromagnetic valve 39 and the pump 35. As in the first embodiment, spraying or not spraying cleaning fluid depends on the need to clean the wiping zone 10 and/or the additional zone 11, as well as the angular position of the wiper 2, which is transmitted to the control module 40 by the electronically controlled electric motor 6.

FIG. 8 shows a third embodiment of the wiper system 1. Unlike the first two embodiments described above, the third embodiment does not include a distribution member. This is because each branch 37, 38 of the cleaning fluid circuit 34 is entirely separate from the other. The cleaning fluid circuit 34 thus comprises a first pump 42 for circulating the cleaning fluid in a first pipe 47 to the first conduit 27 and to the spray element 14, and a second pump 43 for circulating the cleaning fluid in a second pipe 48 to the second conduit 28 and to the spray orifices 30. The cleaning fluid circuit 34 therefore has neither electromagnetic valve nor solenoid valve, the control of the pumps 42, 43 by the control module 40 being sufficient to manage the different possible cleaning fluid sprays. As in the preceding embodiments, the control module 40 activates the cleaning fluid spray or sprays notably as a function of the angular position of the wiper 2, said angular position being transmitted to the control module 40 via the electronically controlled electric motor 6.

FIG. 9 is a diagram showing a plurality of angular positions of the wiper and describes the operation of the control of the fluid spray on the additional zone 11 over time when the wiper is in motion. The description below applies to any of the embodiments described above.

According to the example shown in FIG. 9, the wiper is moved in a direction of movement 44. In other words, the wiper is moving in the upward movement phase. The upward movement phase is a preferred phase for spraying cleaning fluid since it helps to limit the cleaning fluid falling back onto the glazed surface 3.

FIG. 9 shows a first angular position 45 and a second angular position 46. The first angular position 45 and the second angular position 46 correspond respectively to the angular position at which a cleaning fluid spray is started, and the angular position at which the fluid spray is stopped. These angular positions 45, 46 thus enable cleaning fluid to be precisely sprayed onto the additional zone 11 via the spray element described above. Such angular positions 45, 46 are determined as a function of the orientation of the spray direction of the jet of cleaning fluid, as described with reference to FIGS. 2 to 5, as well as the dimensions of the additional zone 11, which have to be taken into account to ensure that the cleaning fluid reaches the whole of the additional zone 11.

FIG. 9 shows how the first angular position 45 and the second angular position 46 are offset in relation to the delimitations of the additional zone 11. Such offsetting is provided to take account of the latency between the activation of the pump and/or the opening of the solenoid valve and the spraying of the jet of cleaning fluid. Therefore, the first angular position 45 is set to anticipate the movement of the wiper and thus to spray the cleaning fluid so that said fluid reaches the additional zone 11 when the angular position of the wiper is facing said additional zone 11. The principle is the same for the second angular position 46, which takes account of the latency when stopping the cleaning fluid spray.

Of course, the invention is not limited to the examples that have just been described and numerous modifications can be made to these examples without departing from the scope of the invention.

The invention, as has just been described, does indeed achieve its stated objective, and makes it possible to propose a wiper enabling a cleaning fluid to be sprayed onto an optical system during the movement thereof. Variants that are not described here may be implemented without departing from the context of the invention, provided that, in accordance with the invention, they comprise a wiper according to the invention.

1. A wiper for a glazed surface of a vehicle,
the wiper comprising:
at least one structural element,
a wiper rubber carried by the structural element,
wherein the wiper rubber is configured to bear against the glazed surface and to sweep a wiping zone of the glazed surface,
at least one end piece arranged at a longitudinal end of the structural element,
at least one conduit extending in a main direction of elongation of the wiper, and
at least one spray element fluidically connected to the conduit and formed on the structural element,
wherein the spray element is configured to spray cleaning fluid in a spray direction onto an additional zone distinct from the wiping zone.

2. The wiper as claimed in claim 1,
wherein the spray direction is oriented at an opening angle of between 3° and 30° in relation to the main direction of elongation of the wiper in a first plane configured to be substantially parallel to the glazed surface.

3. The wiper as claimed in claim 1,
wherein the spray element comprises at least one spray channel that extends in the spray direction of a jet of cleaning fluid.

4. The wiper as claimed in claim 1,
wherein the spray direction is oriented at an attitude angle of between −30° and 20° in relation to a transverse direction of extension perpendicular to the main direction of elongation, in a second plane configured to be substantially perpendicular to the glazed surface.

5. The wiper as claimed in claim 1, wherein the spray element is formed in the structural element.

6. The wiper as claimed in claim 1, wherein the spray element is attached to the structural element.

7. The wiper as claimed in claim 1,
comprising at least one spray device configured to spray cleaning liquid onto the wiping zone.

8. The wiper as claimed in claim 5, wherein the spray device is formed on the structural element.

9. The wiper as claimed in claim 7,
wherein the spray device comprises a plurality of spray orifices,
wherein the spray orifices are arranged along the main direction of elongation of the wiper.

10. The wiper as claimed in claim 7,
wherein the spray element is configured to spray the cleaning fluid from a first side of the wiper and the spray device is configured to spray the fluid from a second side of the wiper, opposite the first side in relation to the main direction of elongation of the wiper.

11. A wiper system for a vehicle,
the wiper system comprising a wiper as claimed in claim 1,
wherein an arm moves the wiper and a cleaning device that is connected fluidically to the conduit and configured to control the circulation of the cleaning fluid, and
wherein the cleaning device comprises:
at least one solenoid valve configured to permit the cleaning fluid to circulate to the spray element, and
a control module for the solenoid valve.

12. The wiper system as claimed in claim 11,
wherein the control module is able to open or close the solenoid valve as a function of a given angular position of the wiper during the movement thereof.

13. The wiper system as claimed in claim 12,
comprising an electronically controlled electric motor able to move the arm with the wiper arranged at the end thereof,
wherein the angular position of the wiper is determined by the electronically controlled electric motor.
